(19) United States
(12) Patent Application Publication
(10) Pub. No.: US 2005/0071833 A1
(43) Pub. Date: Mar. 31, 2005

(54) Utilization of platform-based optimization routines by a computer system

(76) Inventors: Michael A. Rothman, Olympia, WA (US); Vincent J. Zimmer, Federal Way, WA (US); Michael D. Kinney, Olympia, WA (US); Mark S. Doran, Olympia, WA (US)

Correspondence Address: Anthony H. Azure;BLAKELY, SOKOLOFF, TAYLOR & ZAFMAN LLP, Seventh Floor, 12400 Wilshire Boulevard, Los Angeles, CA, 90025, US

(21) Appl. No.: 10/675,877

(22) Filed: Sep. 29, 2003

(51) Int. Cl. G06F 9/45

(52) U.S. Cl. 717/153

(57) ABSTRACT

A method and system to utilize platform-based optimization routines by a computer system. An application executing on the computer system initializes a user library bound to the application. The user library requests that an optimized library be copied into the user space of the computer system. The optimized library includes functions optimized for the hardware configuration of the computer system and is advertised by the firmware of the computer system. The entry points of the optimized functions are exported to the application, the optimized functions corresponding to non-optimized functions of the application. In one embodiment, the optimized library is validated before being copied into user space.

### CROSS REFERENCE TO RELATED APPLICATIONS

The present application is related to U.S. patent application Ser. No. 10/611,122, filed Jun. 30, 2003, entitled “PLATFORM-BASED OPTIMIZATION ROUTINES PROVIDED BY FIRMWARE OF A COMPUTER SYSTEM,” and assigned to the Assignee of the present application.

### BACKGROUND

1. Field of Invention

The field of invention relates generally to computer systems and, more specifically but not exclusively, relates to utilization of platform-based optimization routines by a computer system.

2. Background Information

In a typical PC architecture, the initialization and configuration of the computer system by the Basic Input/Output System (BIOS) is commonly referred to as the pre-boot phase. It is generally defined as the firmware that runs between the processor reset and the first instruction of the Operating System (OS) loader. At the start of a pre-boot, it is up to the code in the firmware to initialize the system to the point that an operating system loaded off of media, such as a hard disk, can take over. The start of the OS load begins the period commonly referred to as OS runtime. During OS runtime, the firmware acts as an interface between software and hardware components of a computer system. As computer systems have become more sophisticated, the operational environment between the application and OS levels and the hardware level is generally referred to as the firmware or the firmware environment.

Modern operating systems often have access to optimized instruction sets (or routines) for execution on particular pieces of hardware. For example, the Intel Pentium III processor includes an instruction set called SSE (Streaming SIMD (Single Instruction, Multiple Data) Extensions). SSE is a set of microprocessor instructions that allow software to tell the processor to carry out specific operations. By using these routines optimized for the Pentium III, operating systems and software applications can maximize the capabilities of the CPU (central processing unit). The optimized instructions reduce the overall number of instructions required to execute a particular program task and as a result can contribute to an overall performance increase of an operating system and/or application.

However, operating system and application code is compiled with specific CPU's in mind and without platform-specific knowledge. For example, software written and compiled for an SSE CPU may not take full advantage of new instructions of an SSE2 CPU. Other hardware components, such as a chipset, may also have optimized routines that cannot be fully anticipated at the time of software production. Additionally, hardware manufacturers are tied to software development to ensure new software can take full advantage of new hardware optimization routines. Often, OS and application release dates lag behind hardware updates and improvements from platform vendors.

### BRIEF DESCRIPTION OF THE DRAWINGS

The present invention is illustrated by way of example and not limitation in the accompanying figures.

FIG. 1 a schematic diagram illustrating one embodiment of a computer system structure in accordance with the teachings of the present invention.

FIG. 2 is a flowchart illustrating one embodiment of the logic and operations to utilize platform-based optimization routines by a computer system in accordance with the teachings of the present invention.

FIG. 3 is a schematic diagram illustrating one embodiment of a computer system structure in accordance with the teachings of the present invention.

FIG. 4 is a schematic diagram illustrating one embodiment of an export table in accordance with the teachings of the present invention.

FIG. 5 is a schematic diagram illustrating one embodiment of a computer system in accordance with the teachings of the present invention.

### DETAILED DESCRIPTION

Embodiments of a method and system to utilize platform-based optimization routines by a computer system are described herein. In the following description, numerous specific details are set forth, such as embodiments pertaining to the Extensible Firmware Interface (EFI) framework standard, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In one embodiment of the present invention, a computer system utilizes platform-based optimization routines. During the pre-boot phase of a computer system, the firmware discovers an optimized library appropriate for the platform configuration and advertises this library to the computer system. During OS runtime, an application (or the OS itself) initializes a user library that is bound to the application. The user library loads the advertised optimized library into user space of the computer system. The optimized library is initialized and exports the start points of optimized functions for use by the application. After the optimized library has been initialized, operations return to the application.

The operating system environment described herein gives an overview of structures common to most operating systems. One skilled in the art will recognize that embodiments of the present invention may be implemented in particular operating system, such as, but not limited to, Microsoft Windows®, the Apple Macintosh OS, UNIX, Linux, or the like. Additionally, examples of C programming code are provided herein as illustrations. It will be understood that embodiments of the present invention are not limited to the programming examples herein and may be implemented using various programming languages and methods.

In one embodiment of the present invention, firmware of a computer system operates in accordance with an extensible firmware framework known as the Extensible Firmware Interface (EFI) (EFI Specification, Version 1.10, Dec. 1, 2002, may be found at http://developer.intel.com/technology/efi). EFI is a public industry specification that describes an abstract programmatic interface between platform firmware and shrink-wrap operating systems or other custom application environments. The EFI framework standard includes provisions for extending BIOS functionality beyond that provided by the BIOS code stored in a platform's BIOS device (e.g., flash memory). More particularly, EFI enables firmware, in the form of firmware modules and drivers, to be loaded from a variety of different resources, including, but not limited to, primary and secondary flash devices, option ROMs (Read-Only Memory), various persistent storage devices (e.g., hard disks, CD-ROM (Compact Disk-Read Only Memory), etc.), and from one or more computer systems over a computer network.

During the pre-boot phase of the computer system, the firmware of the computer system determines if it has access to an optimized library for the platform configuration of the computer system and advertises such a library to make it available to the computer system. In one embodiment, the functions in the optimized routine library correspond to functions in a standard C-library. An optimized routine library provides optimized functions for one or more devices. Such devices include, but are not limited to, a processor, a chipset, a memory module, or the like.

For example, a CPU has optimized routines that software executing on the CPU can take advantage of to speed up the software's performance. When software is compiled, the compiler generates object code according to the CPU that the software will be executed on. However, if software is compiled for an older CPU with an older instruction set, such as the SSE instruction set, then the software cannot take advantage of the new instructions tailored for a newer CPU, such as SSE2 for the Intel Pentium IV. Other devices, such as a chipset, and memory modules, may also have optimized routines available.

In one embodiment, the optimized library is stored in a non-volatile storage (such as Flash memory), an EFI system partition, a Host Protected Area (HPA) of a hard disk, a network repository, or the like. The computer system may have access to more than one optimized library. For example, computer system may have stored optimized libraries having optimized function calls utilizing SSE and SSE2 instruction sets. The computer system may also have optimized libraries stored based on various platform configurations. For example, the computer system may have separate libraries for CPU A combined with chipset 1, CPU A with chipset 2, and CPU A with chipset 3.

Generally, a hardware vendor (e.g., a CPU manufacturer) may provide optimized routine libraries. In some instances, these libraries will be loaded onto a computer system by a platform vendor or a system integrator. Thus, when a new computer system leaves a factory, it will have the latest optimized routines for its newest hardware even though the OS or applications were compiled for older hardware devices. Also, the optimized libraries stored on the computer system can be updated during the life of the computer system.

During the pre-boot phase, the firmware of the computer system identifies the installed hardware devices. The firmware determines if an optimized routine library matching the current platform configuration is available. If such a library is found, this library is advertised for use by an operating system or application to speed up the software's operations.

The optimized library is advertised by the firmware of the computer system. In one embodiment, the optimized routine library is advertised through Advanced Configuration and Power Interface (ACPI) methods (specification available at www.acpi.info). In one embodiment, the optimized routine library is advertised in a Secondary System Description Table (SSDT). In another embodiment, the optimized library is advertised through an ACPI E820 map.

In one embodiment of an EFI-compliant system, the firmware is advertised through a GUID(Globally Unique Identifier)/pointer pair of the EFI Configuration Table. In another embodiment, an EFI-compliant system can use ACPI structures to advertise the optimized routine library. The operating system may find the Root System Description Pointer (RSDP) in an EFI-compliant system through the EFI System Table. The RSDP leads to the SSDT to find the location of the optimized library.

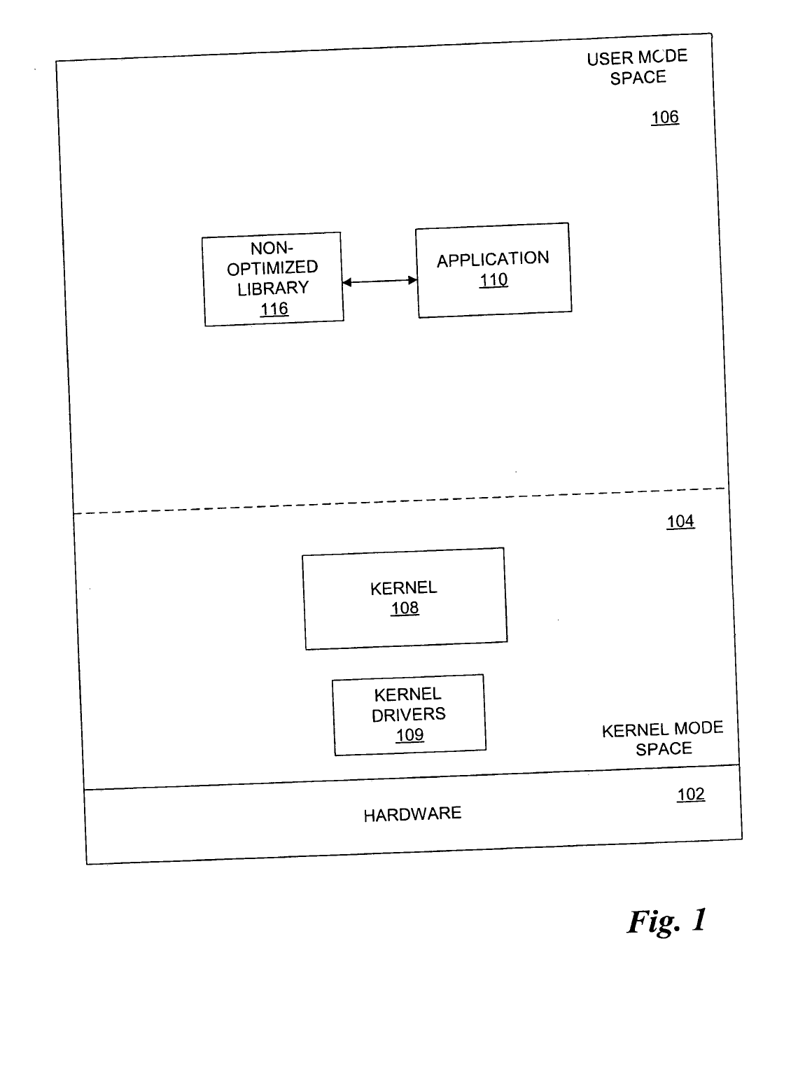

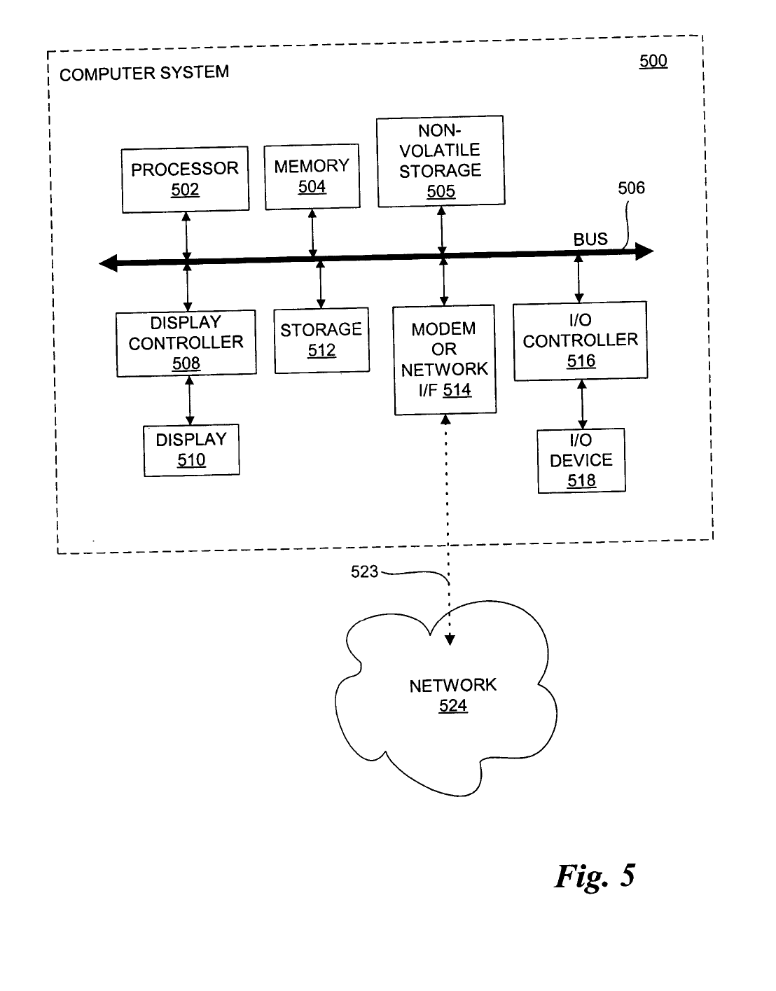

FIG. 1 shows a schematic diagram illustrating a structure to utilize optimized routines of a computer system. One embodiment of a computer system and its hardware components is discussed in conjunction with FIG. 5. A hardware layer of the computer system is shown at 102. Running on top of the hardware layer 102 is the operating system and applications of the computer system. The computer system is divided into a kernel mode space 104 and a user mode space 106. Generally, application code runs in user mode space 106 and the operating system kernel runs in kernel mode space 104. Some aspects of the operating system may also run in user mode space 106. Applications running in user mode space 106 are given limited access to the kernel mode space 104 to prevent an errant application from disrupting the entire computer system. Usually, processes are run as much as possible in user space mode 106 so that a faulty process can be terminated without crashing the whole computer system.

The kernel mode space 104 provides an interface between the user mode space 106 and the hardware layer 102. The kernel mode space includes a kernel 108 and kernel drivers 109. Typically, the kernel 108 performs process management, memory management, file system management, and input/output operations of the computer system. The kernel 108 is generally considered the core of the operating system. Because the code that makes up the kernel 108 is needed continuously, it is usually loaded into memory in an area that is protected so that it will not be overlaid with other less frequently used parts of the operating system. The kernel drivers 109 allow interaction between the operating system and hardware devices of hardware layer 102.

The services of kernel 108 are requested by other parts of the operating system or by application 110 through a specified set of program interfaces known as system calls. User mode applications utilize functionality provided by the kernel 108 in order to access hardware devices such as disk drives, network connections, memory, etc. System calls expose kernel functionality that applications in user mode space 106 may require.

The user mode space 106 includes an application 110. Bound to the application 110 is a non-optimized library 116. The application 110 includes any program running in user mode such as, but not limited to, word processing, databases, Internet browsers, compilers, editors, or the like. Application 110 also includes an OS process running in user space 106. Only one application 110 is described herein for the sake of clarity, but it will be understood the embodiments of the present invention may operate with more than one application.

The non-optimized library 116 is bound to the application 110. The non-optimized library 116 includes functions for the application 110 that were tied to the application at the time of compiling and linking of the application 110. Some functions will trap to the kernel using a system call. Other function calls from the application 110 will not require a system call and the work of the function will be completed in user mode space 106. In one embodiment, the non-optimized library 116 includes standard C-libraries such as, but not limited to, libc.lib, wow32.lib, wsock32.lib, or the like.

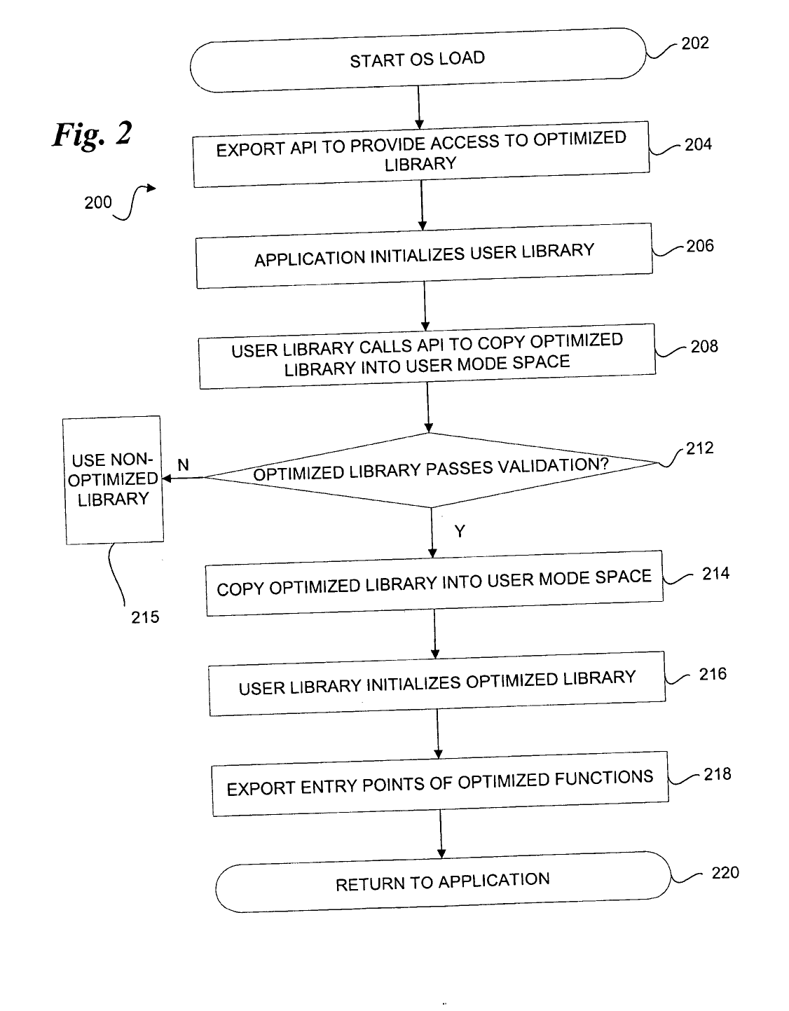

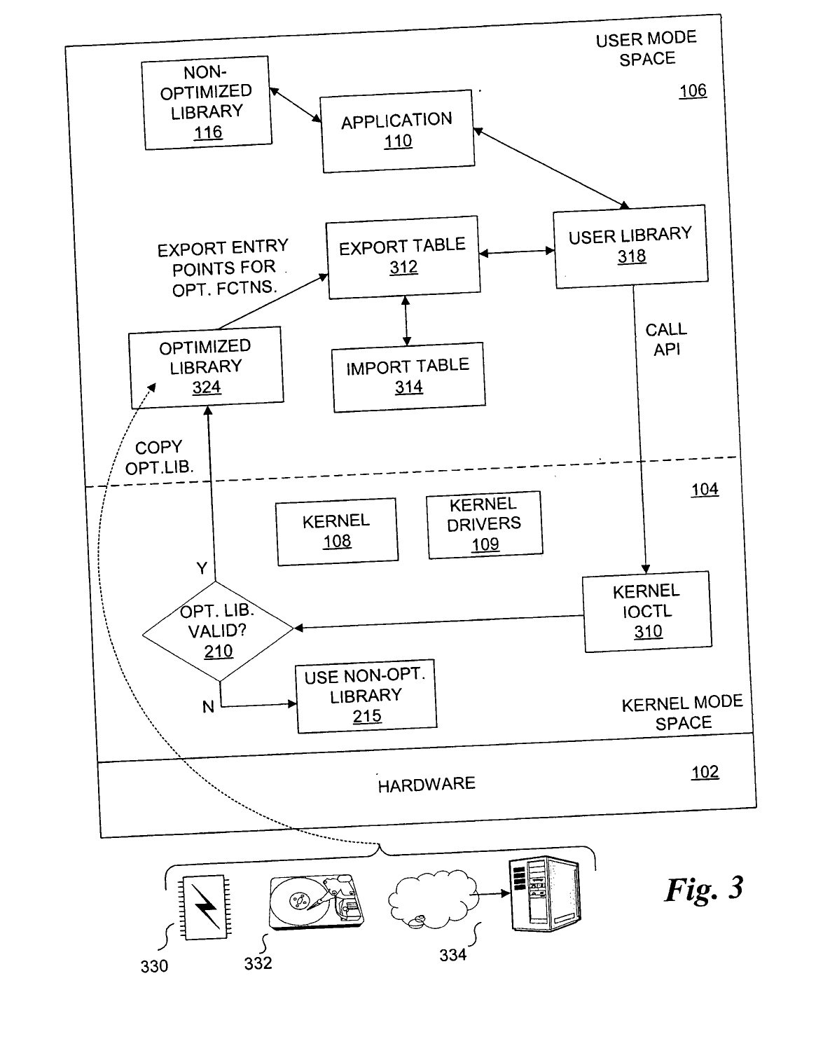

Referring to FIGS. 2 and 3, utilizing optimized routines by a computer system in accordance with one embodiment of the present invention will be discussed. It will be understood that like reference numbers in the FIGS. 1-4 refer to like objects. Referring to FIG. 2, a flowchart 200 shows one embodiment of a method to utilize platform-based optimization routines of computer system. The process begins in a block 202 to start the operating system load. In an EFI-compliant computer system, the OS Loader begins execution.

Proceeding to a block 204, an application programming interface (API) is exported during OS startup to provide access to an optimized library 324. In one embodiment, a kernel driver from the kernel drivers 109 exports the API. In another embodiment, the API is exported by the kernel 108.

The API is an interface that provides consumers residing in user space access to the advertised optimized library. In one embodiment, the API is written once per OS load and enables the proliferation of optimized library data into the kernel and user mode spaces. It should be noted that at block 204 the optimized library has not yet been copied into user space.

Proceeding to a block 206, the application initializes a user library 318. The user library 318 is a library bound to the application 110 at compiling and linking of application 110. The user library includes code that knows how to employ optimized libraries that may be available on a computer system. The user library may also include information about what non-optimized function libraries the application is bound with. In one embodiment, the user library is a standardized library provided as part of a toolkit to aid software developers.

In order to implement the utilization of optimized routines, programmers may provide commands in the source code of the application 110 to invoke the optimized library. In one embodiment, a programmer may include a UserLibInit( ); function call in the source code of the application to initialize the user library. The UserLibInit( ); call returns a Boolean value to indicate if the optimization has been properly established in the computer system. In one embodiment, the programmer may take advantage of such an optimization indicator through the use of an if-then-else coding structure (discussed further below.)

Proceeding to a block 208, the user library 318 calls the API to copy the optimized library into user space. In one embodiment, the user library uses the API to pass the GUID of the optimized library and the address of a buffer in user space that the optimized library is to be copied into. In another embodiment, the API utilizes a kernel IOCTL(Input/Output Control) 310 to copy the optimized library into user space.

Proceeding to a decision block 212, the optimized library is validated before loading the optimized library into user space. This validation may check the authenticity and/or the integrity of the optimized library. In one embodiment, the validation includes verifying a signature of the optimized library. In one embodiment, the validation is performed by the kernel IOCTL 310. In another embodiment, a kernel driver performs the validation of the optimized library.

Generally, the vendor or manufacturer of a hardware device will provide the optimized function routines grouped into an optimized library. In one embodiment, the optimized library is provided with a signature. In one embodiment, the vendor can sign the optimized code with the vendor's private key and the driver that launches the optimized code may use a Machine State Register (MSR) or Industry Standard Architecture (ISA) assisted sequence to authenticate the optimization code.

If the optimized library fails validation, then the optimized library will not be loaded into user space. In one embodiment, the UserLibInit( ); call will return a value of FALSE if the validation fails. The application will execute using the bound non-optimized functions, as shown in a block 215.

If the optimized library is validated, then the logic proceeds to a block 214 to copy the optimized library into user mode space 106. In one embodiment, the user library performs validation of the optimized library after the optimized library is loaded into user space.

As depicted in block 214, the optimized library is copied into user mode space of the computer system. As shown in FIG. 3 the optimized library may be stored in various places including, but not limited to, a Flash memory device 330, a Host Protected Area (HPA) of a hard disk 332, a network repository 334, or the like. It will be understood that the computer system may have access to more than one optimized library and the optimized libraries are not necessarily stored in the same place. In one embodiment, only one optimized library will be advertised by the firmware at OS runtime.

In block 216, the user library initializes the optimized library. In one embodiment, the user library makes an OptimizedLibInit ( ); call to initialize the optimized library. In one embodiment, when the optimized library is initialized, an export table 312 is generated to provide memory addresses for optimized functions of the application 110. The export table 312 is a data structure used to advertise the locations of the optimized library functions and resolve optimized function addresses.

When the application 110 makes an optimized function call, the user library uses the export table 312 to find the address of the optimized function for execution. In one embodiment, each application in user mode space has its own export table. In one embodiment, the export table 312 is similar to the import and export tables associated with a Dynamic Link Library (DLL) of the Microsoft Windows OS.

The optimized library communicates to the user library which functions the optimized library can export. In one embodiment, the optimized library can be identified from its GUID, thus the size of the export table can be anticipated by the computer system even though the optimized functions and their entry points have not yet been exported. The fields of the export table 312 may be initially empty, but the user library uses the optimized library to fill in the export table when the entry points are exported.

In a block 218, the entry points of the optimized functions of the optimized library are exported to the computer system. In one embodiment, the optimized functions and their corresponding memory addresses are entered into the export table 312.

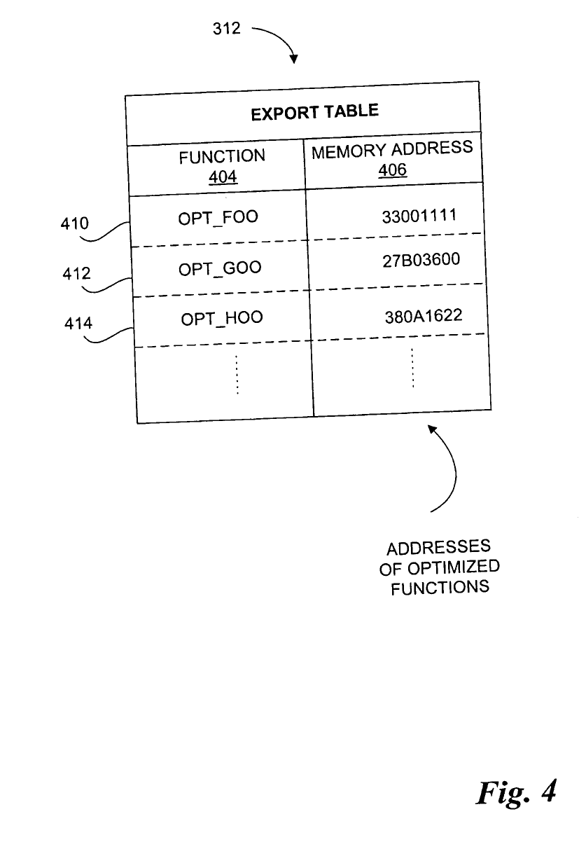

Referring to FIG. 4, one embodiment of export table 312 is shown. The export table 312 includes a function column 404 and a memory address column 406. The export table 312 includes optimized functions OPT_FOO 410, OPT_GOO 412 and OPT_HOO 414 and their memory addresses. It will be understood that the function names and corresponding memory addresses are for the purposes of illustration. The optimized functions in the export table 312 correspond to non-optimized functions “FOO,” “GOO” and “HOO” that are part of a standard library bound to the application. When the optimized library is initialized and the entry points exported, the export table will include the optimized functions and their corresponding memory addresses from the optimized library. In one embodiment, the optimized library will fill in the export table 312.

If an error occurs when the optimized library exports the memory address of an optimized function to the export table 312, the memory address of the corresponding non-optimized function may be substituted in place of the memory address of the optimized function. For example, in FIG. 4, if an error occurs while the memory address of optimized function OPT_FOO 410 is exported, then the memory address of non-optimized FOO may be substituted in its place. Thus, when the application calls OPT_FOO 410, the code for FOO will actually be executed. In this way, other optimized function calls will execute using optimized code even though the optimization of OPT_FOO 410 has been lost.

Referring again to FIG. 3, in one embodiment, an import table 314 may be built by the user library. The import table 314 is a data structure that allows the user library's functions to be registered for use by the optimized library. Thus, if the optimized library needs to utilize the computer system in some manner, the optimized library has access to functions of the user library. For example, if the optimized library needs to print an error message to the screen, the optimized library may call the appropriate function from the user library using the import table 314.

Referring again to FIGS. 2 and 3, after the entry points of the optimized functions have been exported, the logic proceeds to a block 220 to return to the application. The application 110 continues its execution. In one embodiment, when the application 110 initializes the user library, as shown in block 206, the application 110 receives back a Boolean indicator as to whether the user library (and subsequently the optimized library) initialized correctly. Such a Boolean indicator may be used by the application code to determine if optimized instructions will be utilized.

The application may include function calls to optimized code. These function calls will be handled by the user library. The user library will use the export table to find the address of an optimized function in memory. The user library serves as an intermediary to determine the address of the optimized function from the optimized library. The application 110 may be oblivious as to the activities being performed by the user library and the optimized library. From the application's point of view, the application is making a function call to a bound library and receiving back a response as occurs with other libraries bound to the application at compile time.

For purposes of illustration, an example of utilizing platform-optimized routines is provided below. It will be understood that embodiments of the invention are not limited to the if-then-else structure described below, but is provided for the purposes of illustration. The following is an example using standard C-library functions memcmp and memcpy to compare two arrays of data (Array1 and Array2). If the two arrays are not the same, then the contents of Array2 are copied to Array1.

```
Optimizations = UserLibInit( );
. . . . . . . . . . . .
if(Optimizations == FALSE) {
              if(memcmp (Array1, Array2, sizeof(Array1))) {
              memcpy (Array1, Array2, sizeof(Array1));
              }
} else {
              if(Optmemcmp (Array1, Array2, sizeof(Array1))) {
              Optmemcpy (Array1, Array2, sizeof(Array1));
              }
}
. . . . . . . . . . . .
```

The UserLibInit( ); call initializes the user library and optimized library and exports the entry points of the optimized functions. If the UserLibInit( ); is successfully completed, then “Optimizations” is valued at TRUE. If the UserLibInit( ); is not successful, then “Optimizations” is set to FALSE. Thus, if the user library initialization of optimized functions failed, then the application will not be making calls to the optimized functions.

The memcmp and memcpy library functions are calls to assembly instructions (in machine language) that would be used to create the desired operation of comparing the two arrays and copying one array to another if the two arrays are the same.

Assembly code for the non-optimized function memcpy may read as follows:

| | |
|---|---|
| mov al, byte ptr ds:[esi] | ;Copies one byte of data to a register |
| mov BYTE PTR es:[di], al | ;Copies contents of register to the |
| | destination. |
| | ;Repeat in a loop copying data one byte at a |
| | time. |

while the optimized function Optmemcpy from an optimized library may read as follows:

| | |
|---|---|
| movq mm0, QWORD PTR ds:[esi] | ;Copies 8 bytes of data to a register |
| movq QWORD PTR es:[edi], mm0 | ;Copies contents of register to the |
| | ;destination. Repeat in a loop as |
| | ;necessary. |

The optimized function executes more quickly because of the higher throughput of moving data in larger pieces. Thus, by using the optimized function, the application will execute more efficiently by taking advantage of CPU instructions that were not compiled and linked in the application. Optmemcmp and Optmemcpy will execute the optimized code provided by the platform firmware instead of the non-optimized code as originally shipped with the application software.

In order to take advantage of optimized functions of a platform, software developers may provide source code, as shown in the above example, to make optimized function calls. These optimized function calls may be provided to programmers during coding of an application. However, the optimized code corresponding to these optimized calls will be tailored for a particular platform when the platform is shipped. Thus, the programmer may include an OptMemCpy call in the source code. This source code will be compiled and linked using the user library. However, the code for these optimized functions calls will not be provided until the application is executed on a specific computer system having stored an optimized library.

Also, the software developer may choose which functions to be optimized using the if-then-else structure shown above. Adding additional lines of code may be tolerated in order to gain execution speed of certain functions. In one embodiment, the additional code to utilize optimized routines may be less than 2% of the total size of the application.

It will be appreciated that each application in user space will go through the procedures as described above. In one embodiment, each application will obtain its own copy of the optimized library and generate its own export table as appropriate. In another embodiment, the optimized library will be loaded once into user space and shared by multiple applications. However, each application will update its own export table because each application will have its own user library. In another embodiment, an application will construct a new export table each time the application is launched.

Also, it will be appreciated that not all applications of a computer system need to employ an optimized library. Applications that have not been coded to look for an optimized library advertised by the firmware will execute with their bound non-optimized library. While other software (e.g., an application, an operating system, etc.) of the same computer system may take advantage of the optimized library.

FIG. 5 is an illustration of one embodiment of an example computer system 500 on which embodiments of the present invention may be implemented. Computer system 500 includes a processor 502 coupled to a bus 506. Memory 504, storage 512, non-volatile storage 505, display controller 508, input/output controller 516 and modem or network interface 514 are also coupled to bus 506. The computer system 500 interfaces to external systems through the modem or network interface 514. This interface 514 may be an analog modem, Integrated Services Digital Network (ISDN) modem, cable modem, Digital Subscriber Line (DSL) modem, a T-1 line interface, a T-3 line interface, token ring interface, satellite transmission interface, or other interfaces for coupling a computer system to other computer systems. A carrier wave signal 523 is received/transmitted by modem or network interface 514 to communicate with computer system 500. In the embodiment illustrated in FIG. 5, carrier waive signal 523 is used to interface computer system 500 with a computer network 524, such as a local area network (LAN), wide area network (WAN), or the Internet. In one embodiment, computer network 524 is further coupled to a remote computer (not shown), such that computer system 500 and the remote computer can communicate.

Processor 502 may be a conventional microprocessor including, but not limited to, an Intel Corporation x86, Pentium, or Itanium family microprocessor, a Motorola family microprocessor, or the like. Memory 504 may include, but not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Display controller 508 controls in a conventional manner a display 510, which in one embodiment may be a cathode ray tube (CRT), a liquid crystal display (LCD), and active matrix display or the like. An input/output device 518 coupled to input/output controller 516 may be a keyboard, disk drive, printer, scanner and other input and output devices, including a mouse, trackball, trackpad, joystick, or other pointing device.

The computer system 500 also includes non-volatile storage 505 on which firmware and/or data may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), or the like.

Storage 512 in one embodiment may be a magnetic hard disk, an optical disk, or another form of storage for large amounts of data. Some data may be written by a direct memory access process into memory 504 during execution of software in computer system 500. It is appreciated that software may reside in storage 512, memory 504, non-volatile storage 505 or may be transmitted or received via modem or network interface 514.

For the purposes of the specification, a machine-readable medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-readable medium includes, but is not limited to, recordable/non-recordable media (e.g., a read only memory (ROM), a random access memory (RAM), a magnetic disk storage media, an optical storage media, a flash memory device, etc.). In addition, a machine-readable medium can include propagated signals such as electrical, optical, acoustical or other form of propagated signals (e.g., carrier waves, infrared signals, digital signals, etc.).

It will be appreciated that computer system 500 is one example of many possible computer systems that have different architectures. For example, computer systems that utilize the Microsoft Windows operating system in combination with Intel microprocessors often have multiple buses, one of which may be considered a peripheral bus. Network computers may also be considered as computer systems that may be used with the present invention. Network computers may not include a hard disk or other mass storage, and the executable programs are loaded from a corded or wireless network connection into memory 504 for execution by processor 502. In addition, handheld or palmtop computers, which are sometimes referred to as personal digital assistants (PDAs), may also be considered as computer systems that may be used with the present invention. As with network computers, handheld computers may not include a hard disk or other mass storage, and the executable programs are loaded from a corded or wireless network connection into memory 504 for execution by processor 502. A typical computer system will usually include at least a processor 502, memory 504, and a bus 506 coupling memory 504 to processor 502.

It will also be appreciated that in one embodiment, computer system 500 is controlled by operating system software that includes a file management system, such as a disk operating system, which is part of the operating system software. For example, one embodiment of the present invention utilizes Microsoft Windows as the operating system for computer system 500. In other embodiments, other operating systems that may also be used with computer system 500 include, but are not limited to, the Apple Macintosh operating system, the Linux operating system, the Microsoft Windows CE operating system, the Unix operating system, the 3Com Palm operating system, or the like.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

1. A method, comprising:
copying an optimized library into a user space of a computer system, the optimized library including an optimized function for the computer system; and
exporting an entry point for the optimized function to be available to an application executing on the computer system.

2. The method of claim 1, further comprising initializing a user library bound to the application, the user library to initiate the copying of the optimized library.

3. The method of claim 1, further comprising making a call to the optimized function by the application to initiate execution of the optimized function.

4. The method of claim 1 wherein exporting the entry point comprises exporting a memory address of the optimized function to a data structure associated with the application.

5. The method of claim 1, further comprising allocating a buffer in user space to receive the optimized library when copied into the user space.

6. The method of claim 1, further comprising validating the optimized library before copying the optimized library into the user space.

7. The method of claim 6 wherein the optimized library is validated by verifying a signature of the optimized library.

8. The method of claim 1, further comprising advertising the optimized library by firmware of the computer system during operating system runtime.

9. The method of claim 1 wherein the plurality of optimized functions include code to optimize at least one operation of at least one hardware device of the computer system.

10. The method of claim 9 wherein the at least one hardware device includes a Central Processing Unit (CPU) of the computer system.

11. An article of manufacture comprising:
a machine-readable medium including a plurality of instructions which when executed perform operations comprising:
receiving a first request at a user library from an application executing on a computer system to initialize the user library;
copying an optimized library into a user space of a computer system in response to a second request by the user library, the optimized library including an optimized function for a hardware device of the computer system; and
initiating a third request to initialize the optimized library to export an entry point of the optimized function to a data structure associated with the application.

12. The article of manufacture of claim 11 wherein execution of the plurality of instructions further perform operations comprising returning a failure indicator by the user library to the application if the initialization of the user library failed.

13. The article of manufacture claim 11 wherein execution of the plurality of instructions further perform operations comprising requesting the operating system copy the optimized library into the user space via an application program interface (API).

14. The article of manufacture of claim 11 wherein execution of the plurality of instructions further perform operations comprising allocating a buffer in user space to receive the optimized library when copied into the user space.

15. The article of manufacture of claim 11 wherein the at least one hardware device includes a Central Processing Unit (CPU) of the computer system.

16. The article of manufacture of claim 11 wherein execution of the plurality of instructions further perform operations comprising generating the data structure for the application, the data structure to include a memory address corresponding to the optimized function.

17. The article of manufacture of claim 16 wherein exporting the entry point of the optimized function comprises entering a memory address of the optimized function in the data structure.

18. The article of manufacture of claim 11 wherein execution of the plurality of instructions further perform operations comprising exporting an entry point of a non-optimized function to the data structure in place of the entry point of the optimized function if an error occurs while exporting the entry point of the optimized function.

19. The article of manufacture of claim 11 wherein execution of the plurality of instructions further perform operations comprising generating a second data structure to register a function of the user library for use by the optimized library.

20. A computer system, comprising:
a processor; and
a storage device coupled to the processor, the storage device including instructions which when executed by the processor perform operations comprising:
recognizing an optimized library advertised by firmware of the computer system, the optimized library including a plurality of optimized functions for at least one hardware device of the computer system;
copying the optimized library into a user space of the computer system; and
exporting a plurality of entry points corresponding to the plurality of optimized functions to the computer system.

21. The computer system of claim 20 wherein the optimized library is stored in firmware of the computer system.

22. The computer system of claim 20 wherein the optimized library is stored on a hard disk accessible to the computer system.

23. The computer system of claim 20 wherein execution of the instructions further perform operations comprising validating the optimized library before copying the optimized library into the user space.

24. The computer system of claim 20 wherein the firmware to operate in accordance with an Extensible Firmware Interface (EFI) framework standard.

25. The computer system of claim 20 wherein the at least one hardware device includes a Central Processing Unit (CPU) of the computer system.

26. The computer system of claim 20 wherein exporting the plurality of entry points comprises providing a plurality memory addresses corresponding to the plurality of optimized functions to a data structure associated with the application.
